(19) United States
(12) Patent Application Publication
(10) Pub. No.: US 2007/0284470 A1
(43) Pub. Date: Dec. 13, 2007

(54) Single reel tape cartridge and method of manufacturing the same

(75) Inventor: Hidetoshi Yamamoto, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/806,755

(22) Filed: Jun. 4, 2007

(30) Foreign Application Priority Data
Jun. 7, 2006 (JP) 2006-158684

(51) Int. Cl. G11B 23/107

(52) U.S. Cl. 242/348

(57) ABSTRACT

A single reel tape cartridge includes a tape, a reel around which the tape is wound, a cartridge case for accommodating the reel, and a leader tape joining the tape and the reel. The reel includes a hub around which the tape and the leader tape are wound, and an engagement member for engaging with the hub. One end of the leader tape is held between the hub and the engagement member, and the other end of the leader tape is joined to the tape.

### CROSS REFERENCE TO RELATED APPLICATIONS

This application claims the benefit of Japanese Patent Application No. 2006-158684 filed on Jun. 7, 2006, the disclosure of which is incorporated herein by reference.

### BACKGROUND OF THE INVENTION

1. Field of the Invention

The present invention relates to a single reel tape cartridge accommodating a single reel, and a method of manufacturing the same.

2. Description of the Related Art

A conventional single reel tape cartridge has been manufactured with a manufacturing method as shown in FIG. 7 A, FIG. 7B and FIG. 7C (see Japanese Laid-Open Patent Application, Publication No. 2005-322353 (paragraphs 0029-0031, FIG. 3), Japanese Laid-Open Patent Application, Publication No. 2003-022648 (paragraph 0030), and Japanese Laid-Open Patent Application, Publication No. 2005-259273 (FIG. 3)). FIG. 7A, FIG. 7B and FIG. 7C are explanatory views sequentially showing the method of manufacturing the conventional single reel tape cartridge. FIG. 7A shows a state when a liquid is applied to a magnetic tape; FIG. 7B, when an end of the magnetic tape is attached to a hub; and FIG. 7C, when the magnetic tape is wound around the hub. Each figure is composed of a front view provided on a left side and a side view provided on a right side. In the side view, a magnetic tape conveying unit 105 is not shown.

The conventional manufacturing method includes the steps of:

(1) setting a reel 102, around which a magnetic tape MT has not yet been wound, into a cartridge case 101;
(2) making a magnetic tape conveying unit 105 adsorb an end MT1 of the magnetic tape MT, the magnetic tape conveying unit 105 having a sponge 103 soaked with a liquid L such as alcohol, at its tip, and also having a magnetic tape adsorbing part 104 for adsorbing the magnetic tape MT;
(3) inserting the magnetic tape conveying unit 105 into the cartridge case 101, and bringing the sponge 103 into contact with a surface of a hub 102a of the reel 102 to apply the liquid L thereto;
(4) bringing the end MT1 of the magnetic tape MT into contact with the surface of the hub 102 having the liquid L applied thereto to attach the end MT1 of the magnetic tape MT to the hub 102a; and
(5) rotating the reel 102 to wind up the magnetic tape MT.

In the conventional manufacturing method, however, the liquid L applied to the surface of the hub 102a may evaporate to make the surface dry. Hence, when the magnetic tape MT is wound around the hub 102a, the end MT1 of the magnetic tape MT may drop off and bend down from the hub 102a as shown in the front view of FIG. 7C.

Further, in the conventional manufacturing method, when the magnetic tape MT is wound around the hub 102a, the magnetic tape MT may deviate in its width direction. Then, an edge E of the magnetic tape MT may run over a flange 102b of the reel 102, as shown in the side view of FIG. 7C.

When a bend 107 or a deviation 108 as described above is generated to cause a difference in level on the magnetic tape MT, and, if the magnetic tape MT is wound further, the wound magnetic tape MT is locally distorted. Such a local distortion is visible as a radial pattern on an edge face of the wound magnetic tape MT.

The local distortion of the magnetic tape MT causes such problems that, when a servo signal is written in the magnetic tape MT, a space between a servo write head and the magnetic tape MT fluctuates (a spacing loss). This results in an error in writing or reading a servo signal in the magnetic tape MT, or even in recording or reproducing data. Along with the increasing recording capacity of magnetic tape cartridges in recent years, the magnetic tape MT has been made extremely thinner and thus more susceptible to distortion. When a thickness of the magnetic tape MT is, in particular, 6.6 μm or less, the above-mentioned problems notably occur.

The present invention has been made in an attempt to provide a single reel tape cartridge with a tape not subjected to a local distortion, and a method of manufacturing the same.

### SUMMARY OF THE INVENTION

According to a first aspect of the present invention, a method of manufacturing a single reel tape cartridge is provided. The single reel tape cartridge includes a reel composed of a hub and an engagement member for engaging with the hub to hold a leader tape with the hub; and a tape wound around the reel via the leader tape. The method of manufacturing the single reel tape cartridge includes; providing the leader tape having a first end and a second end; holding the first end of the leader tape between the hub and the engagement member; winding the leader tape around the reel; setting the reel with the leader tape wound therearound, into a cartridge case; drawing the second end of the leader tape out of the cartridge case; joining the second end of the leader tape to the tape; and winding the tape around the reel via the leader tape.

In the first aspect of the present invention, the first end of the leader tape is held between the hub and the engagement member, so that the first end of the leader tape does not bend, or an edge thereof does not run over a flange, as happens in the conventional manufacturing method.

In the first aspect, after setting the reel with the leader tape wound therearound, into a cartridge case, the second end of the leader tape is drawn out of the cartridge case. Then the second end of the leader tape is joined to the tape, to thereby wind the tape, which is joined to the hub via the leader tape, around the reel. When the tape is wound around the reel, the leader tape is not bent or deviated. Thus, the tape wound around the leader tape does not suffer from a local distortion.

According to a second aspect of the present invention, the leader tape may be wound around the hub one or more turns (where one turn is 360 degrees) to reduce a difference in level between the hub and the engagement member.

In the second aspect of the present invention, such a level difference may be generated between the hub and the engagement member, when the leader tape is held between hub and the engagement member, which are engaged with each other. The level difference can be reduced by winding the leader tape around the hub one or more turns. Thus, the method according to the present invention does not cause a local distortion in the tape due to the level difference between the hub and the engagement member.

The number of turns of winding the leader tape around the hub can be suitably set based on a relation between a height of the level difference and a thickness of the leader tape.

According to a third aspect of the present invention, the thickness t of the leader tape, the number of turns n of winding the leader tape, and a height of the level difference d may satisfy a relation represented by the following expression (1):

Level difference d×90%≦Thickness t×Number of turns n (1)

In the third aspect of the present invention, the present inventors made intensive studies to find that a negative effect on the tape by the level difference could be reduced, if the thickness t of the leader tape, the number of turns n of winding the leader tape, and the height of the level difference d satisfy the relation represented by the expression (1). The method according to the present invention can thus prevent the tape from being locally distorted.

According to a fourth aspect of the present invention, the thickness of the tape may be 6.6 μm or less.

In the fourth aspect of the present invention, the method does not cause the bend of the first end of the leader tape or the deviation of the edge thereof. Even when the tape with a thickness of 6.6 μm or less is used, the tape does not suffer from a local distortion. Thus, the method can make the thickness of the tape smaller and can increase the number of turns of winding the tape (that is, can increase a recording capacity of the single reel tape cartridge), while preventing the tape from being locally distorted.

According to a fifth aspect of the present invention, in the method, a protective tape may be attached to a portion nearer to the first end of the leader tape, at which the leader tape is held between the hub and the engagement member.

In the fifth aspect of the present invention, the protective tape makes the portion stronger. Thus, the method can prevent the leader tape from being easily broken, when the first end of the leader tape is held between the hub and the engagement member.

According to a sixth aspect of the present invention, there is provided a single reel tape cartridge which includes a tape, a reel around which the tape is wound, a cartridge case for accommodating the reel, and a leader tape joining the tape and the reel. The reel includes a hub around which the tape and the leader tape are wound, and an engagement member for engaging with the hub. The first end of the leader tape is held between the hub and the engagement member, and the second end of the leader tape is joined to the tape.

In the sixth aspect of the present invention, because the first end of the leader tape is held between the hub and the engagement member, the first end of the leader tape does not bend, or the edge thereof does not run over a flange. Thus the tape does not suffer from a local distortion.

According to a seventh aspect of the present invention, the leader tape may be wound around the hub one or more turns.

In the seventh aspect of the present invention, even if a level difference is generated between the hub and the engagement member, the level difference can be reduced by winding the leader tape around the hub one or more turns. Thus the configuration can prevent the tape from being locally distorted.

The number of turns of winding the leader tape around the hub can be suitably set based on the relation between the height of the level difference and the thickness of the leader tape.

According to an eighth aspect of the present invention, the thickness t of the leader tape, the number of turns n of winding the leader tape, and the height of the level difference d may satisfy the relation represented by the following expression (1):

Level difference d×90%≦Thickness t×Number of turns n (1)

In the eighth aspect of the present invention, the level difference between the hub and the engagement member can be suitably reduced.

According to a ninth aspect of the present invention, the thickness of the tape may be 6.6 μm or less.

In the ninth aspect of the present invention, the thickness of the tape can be made smaller, and the number of turns of winding the tape can be increased, while preventing the tape from being locally distorted.

According to a tenth aspect of the present invention, a protective tape may be attached to a portion nearer to the first end of the leader tape, at which the leader tape is held between the hub and the engagement member.

In the tenth aspect of the present invention, the protective tape makes the portion stronger. Thus, the configuration can prevent the leader tape from being easily broken, when the first end of the leader tape is held between the hub and the engagement member.

Other features and advantages of the present invention will become more apparent from the following detailed description of the invention, when taken in conjunction with the accompanying exemplary drawings.

### BRIEF DESCRIPTION OF THE DRAWINGS

FIG. 1 is an exploded perspective view showing a magnetic tape cartridge according to a first embodiment of the present invention.

FIG. 2 is an exploded perspective view showing a reel of the magnetic tape cartridge according to the first embodiment.

FIG. 3A and FIG. 3B are partial cross sectional views showing the reel of the magnetic tape cartridge according to the first embodiment. FIG. 3A shows a state before the reel is engaged with an engagement member, and FIG. 3B shows a state after the reel is engaged therewith.

FIG. 4 is a front view showing a magnetic tape cartridge manufacturing device according to the first embodiment.

FIG. 5 is an explanatory view showing a method of manufacturing the magnetic tape cartridge according to the first embodiment.

FIG. 6A and FIG. 6B are partial cross sectional views showing a reel of a magnetic tape cartridge according to a second embodiment. FIG. 6A shows a state before the reel is engaged with an engagement member, and FIG. 6B shows a state after the reel is engaged therewith.

FIG. 7A, FIG. 7B and FIG. 7C are explanatory views sequentially showing a method of manufacturing a conventional single reel tape cartridge. FIG. 7A shows a state when a liquid is applied to a magnetic tape; FIG. 7B, when an end of the magnetic tape is attached to a hub; and FIG. 7C, when the magnetic tape is wound around the hub. Each figure is composed of a front view provided on a left side and a side view provided on a right side.

### DETAILED DESCRIPTION OF THE EXEMPLARY EMBODIMENT

Next are described exemplary embodiments of the present invention with reference to the related drawings. In the first embodiment, description is made assuming that a single reel tape cartridge used herein is a magnetic tape cartridge complying with the LTO (Linear Tape-Open) Standard.

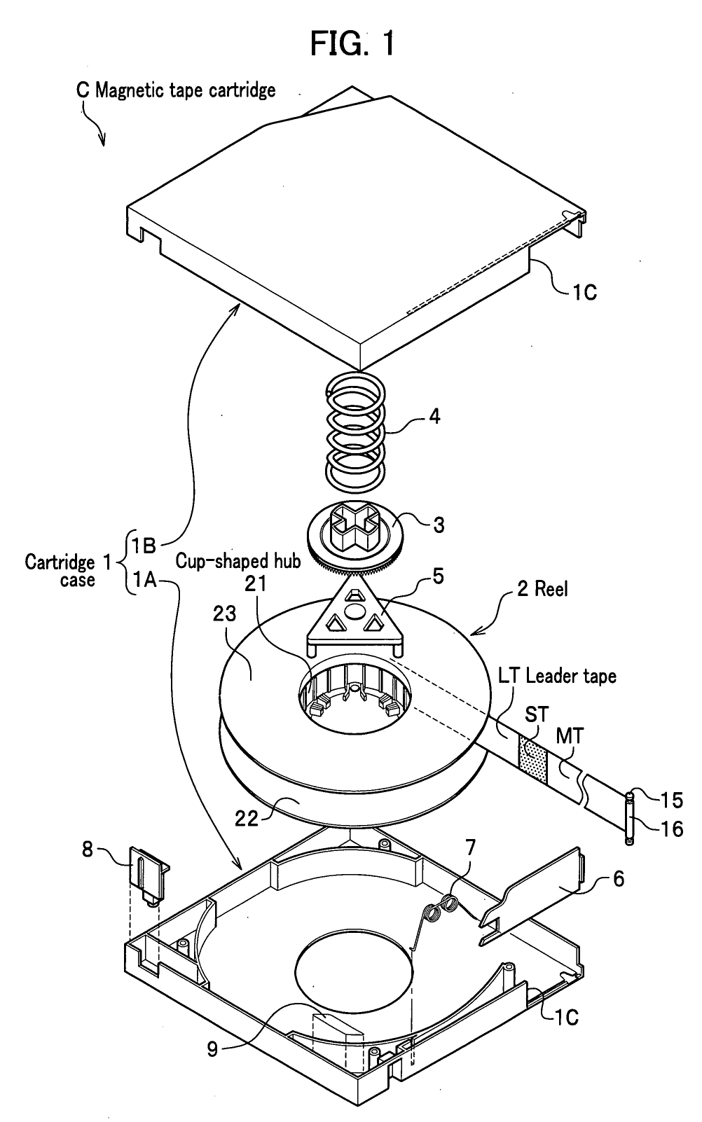

As shown in FIG. 1, a magnetic tape cartridge C according to the first embodiment includes, inside a cartridge case 1 which is divided into a lower half 1A and an upper half 1B, a single reel 2 around which a leader tape LT is wound in advance; a lock plate 3 and a compression coil spring 4 each for locking rotation of the reel 2; a release pad 5 for releasing a lock of the reel 2; a sliding door 6 for opening/closing a tape drawing-out opening 1C extending across the lower half 1A and the upper half 1B; a torsion coil spring 7 for giving momentum to the sliding door 6 so as to close the tape drawing-out opening 1C; a safety lug 8; and a cartridge memory chip 9.

The magnetic tape cartridge C according to the first embodiment has the leader tape LT which joins the reel 2 and the magnetic tape MT, as shown in FIG. 1. One end of the magnetic tape MT is joined to an end of the leader tape LT via a splicing tape ST. The other end of the magnetic tape MT is wound around a leader pin 15. A clip 16 having a substantially C-shaped cross section is then struck to and fitted with the leader pin 15 from outside, thus firmly fixing the other end of the magnetic tape MT between the leader pin 15 and the clip 16.

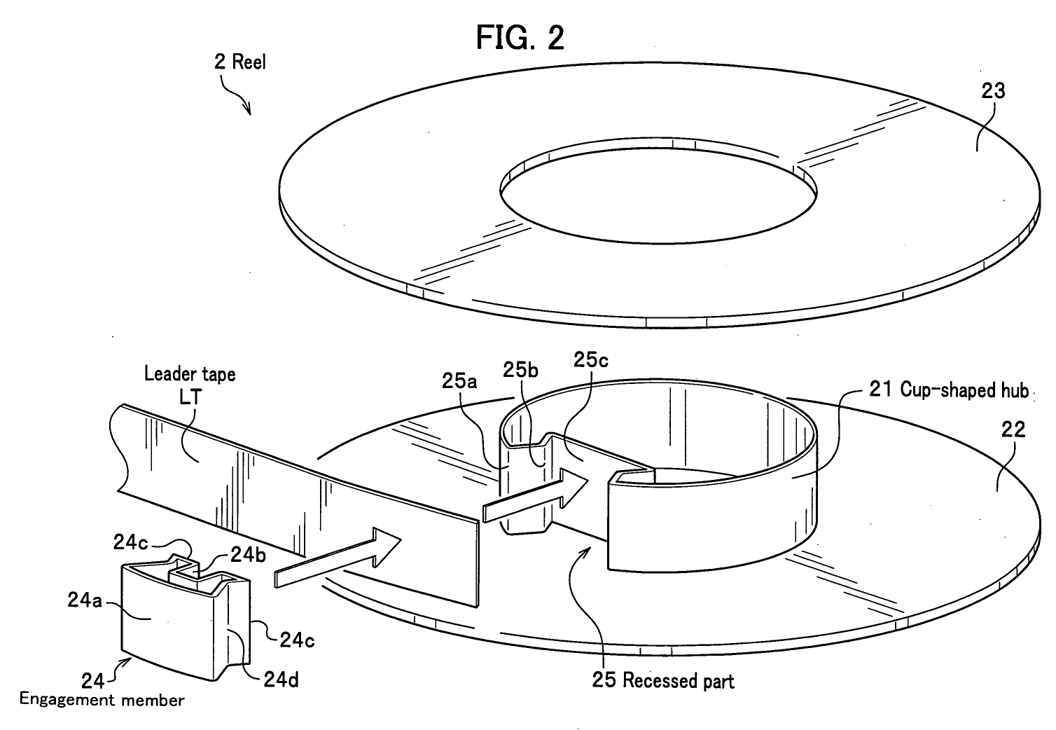

As shown in FIG. 2, the reel 2 includes a cup-shaped hub 21 which has an opening toward the upper half 1B; a lower flange 22 unitarily formed with the cup-shaped hub 21 on a lower half 1A side; an upper flange 23 welded on the opening of the cup-shaped hub 21; and an engagement member 24 for engaging with the cup-shaped hub 21.

The cup-shaped hub 21 is a hub around which the leader tape LT and the magnetic tape MT (see FIG. 1) are wound, and is a cylindrical member having a bottom and the opening toward the upper half 1B. The release pad 5, the lock plate 3 and the compression coil spring 4 are mounted onto the cup-shaped hub 21 in this order (see FIG. 1). An outer circumferential surface of the cup-shaped hub 21 has a recessed part 25 for engaging with the engagement member 24. The recessed part 25 has an intermediate portion 25b with a width smaller than those of an opening portion 25a and a bottom portion 25c.

The engagement member 24 is engaged with the cup-shaped hub 21 to hold the leader tape LT between itself and the cup-shaped hub 21. The engagement member 24 includes a curved portion 24a having a substantially equal curvature to that of the outer circumferential surface of the cup-shaped hub 21; a cutout portion 24b provided on an opposite side of the curved portion 24a (namely, on a bottom portion 25c side); and engagement portions 24c,24c provided on both sides of the cutout portion 24b. Lateral portions 24d,24d adjoining the respective engagement portions 24c,24c have dogleg cross sections, which correspond to a shape of the intermediate portion 25b of the recessed part 25.

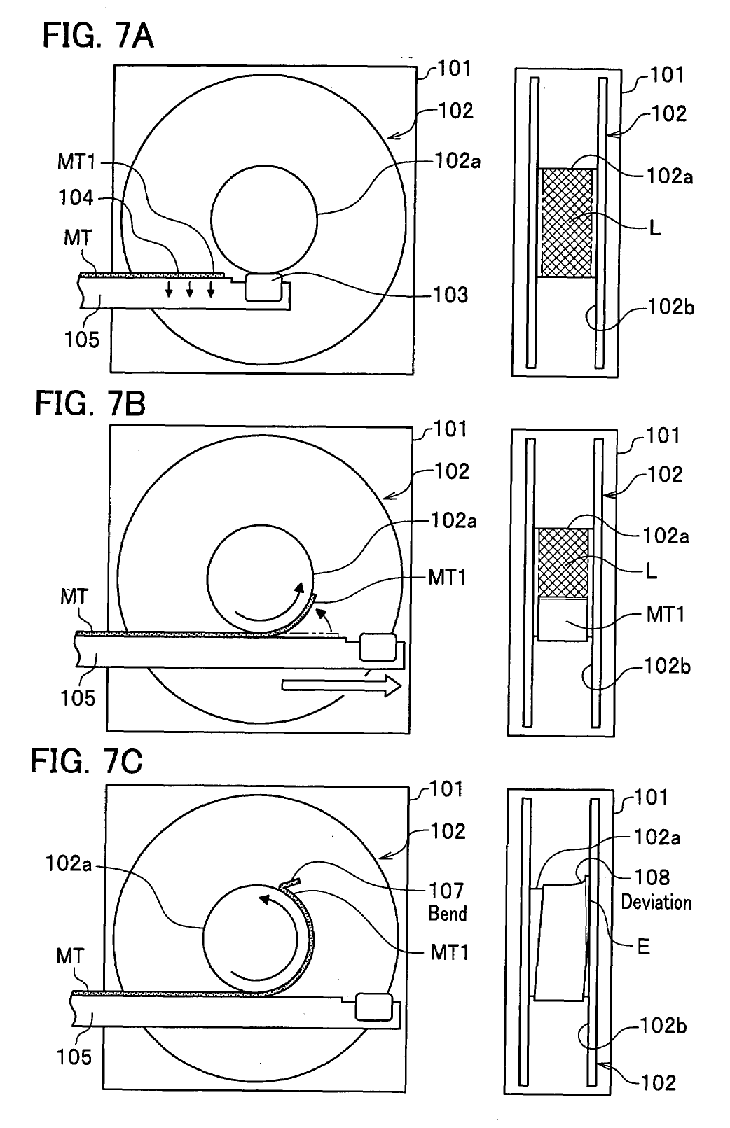

The leader tape LT joins the cup-shaped hub 21 and the magnetic tape MT. One end of the leader tape LT is held between the cup-shaped hub 21 and the engagement member 24. Therefore, the problems caused in the conventional manufacturing method shown in FIG. 7C, such as the bend 107 and the deviation 108 do not occur. As the leader tape LT, for example, a conventional magnetic tape having a thickness larger than that of the magnetic tape MT for use in the first embodiment may be used. More specifically, a conventional magnetic tape having a thickness of 15 μm may be used as the leader tape LT, if the magnetic tape MT having the thickness of 6.6 μm is used with a purpose of rendering a large recording capacity to the magnetic tape cartridge C of the first embodiment.

Materials for the leader tape LT include, for example, polyesters such as a polyethylene terephthalate (PET) and a polyethylene naphthalate (PEN); polyolefins such as a polypropylene; cellulose derivatives such as a nitrocellulose; polymers such as a polyamide, a polyimide, a polyvinyl chloride, a polycarbonate, and an aramid.

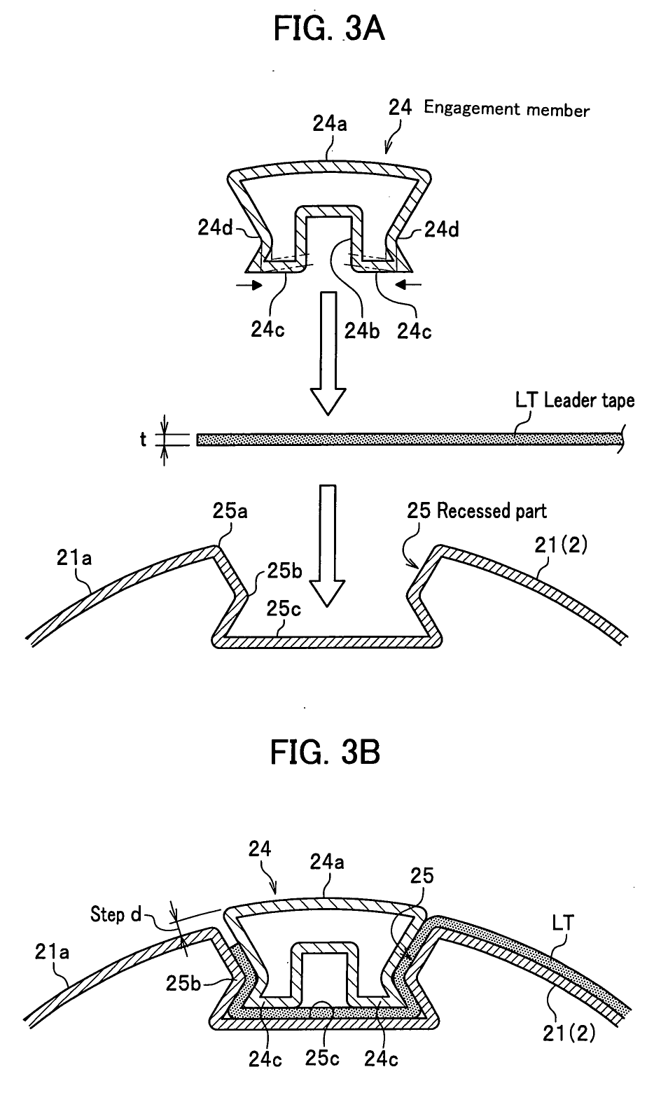

Next is described how the leader tape LT is fixed onto the cup-shaped hub 21 with reference to FIG. 3A and FIG. 3B.

As shown in FIG. 3A, one end of the leader tape LT is set between the engagement member 24 and the recessed part 25. The engagement member 24 is pressed into the recessed part 25, that is, the leader tape LT is also pressed by the engagement portions 24c,24c of the engagement member 24. As the engagement portions 24c,24c are guided along an inwardly-angled sidewall between the opening portion 25a and the intermediate portion 25b, both of the engagement portions 24c,24c are bent inwardly toward the cutout portion 24b.

As shown in FIG. 3B, when the engagement member 24 is further pressed into the recessed part 25, the engagement portions 24c,24c squeeze through the intermediate portion 25b to finally reach the bottom portion 25c. Just then, the engagement portions 24c,24c restore their original shapes without bending, and are engaged with the intermediate portion 25b of the recessed part 25. Together with the engagement member 24, the leader tape LT is pressed by the engagement portions 24c,24c into the recessed part 25, resulting that the leader tape LT is held between the engagement member 24 and the recessed part 25 (namely, the cup-shaped hub 21).

When the leader tape LT is held between the engagement member 24 and the recessed part 25, which are engaged with each other, a level difference d is generated between the curved portion 24a of the engagement member 24 and an outer circumferential surface 21a of the cup-shaped hub 21, as shown in FIG. 3B. The leader tape LT has a length adapted to be wound around the cup-shaped hub 21 a predetermined number of turns so as to reduce the level difference.

The inventors have found that the level difference can be reduced, if a thickness t of the leader tape LT, the number of turns n of winding the leader tape, and a height of the level difference d satisfy a relation represented by the following expression (1):

Level difference d×90%≦Thickness t×Number of turns n (1)

For example, when the level difference d is 50 μm, and the thickness t of the leader tape LT is 15 μm, the level difference d can be reduced, if the leader tape LT is wound around the cup-shaped hub 21 three turns or more. This can prevent the magnetic tape MT from being locally distorted due to the level difference d. The leader tape LT preferably but not necessarily has a thickness t larger than that of the magnetic tape MT t to reduce the level difference d.

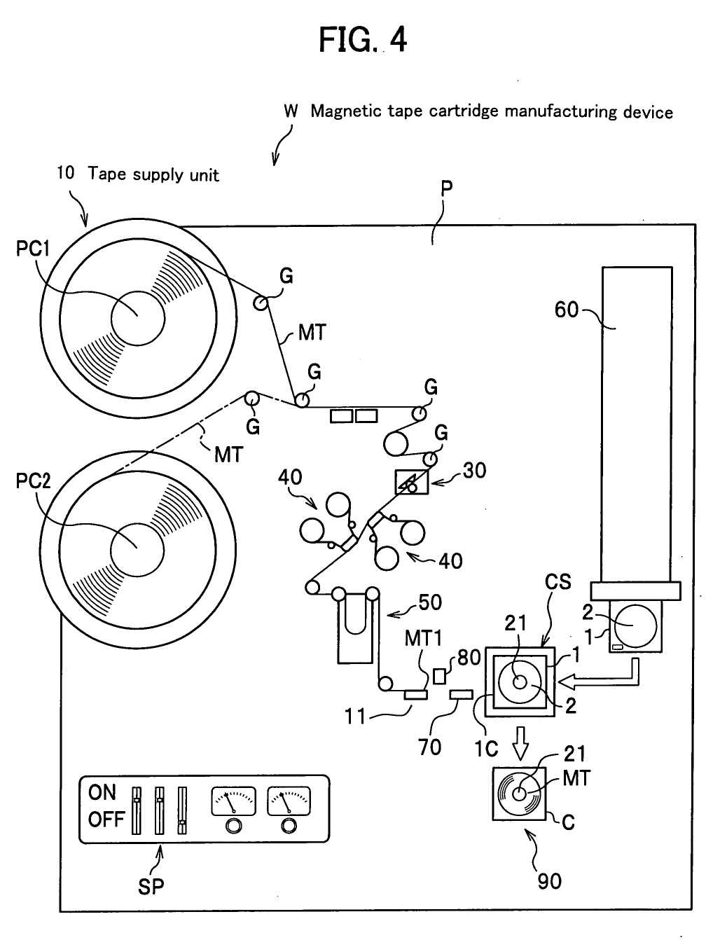

After the leader tape LT is wound around the reel 2, the reel 2 is set in the cartridge case 1, and is stocked in a cartridge case supply unit 60 of a magnetic tape cartridge manufacturing device W to be described later (see FIG. 4).

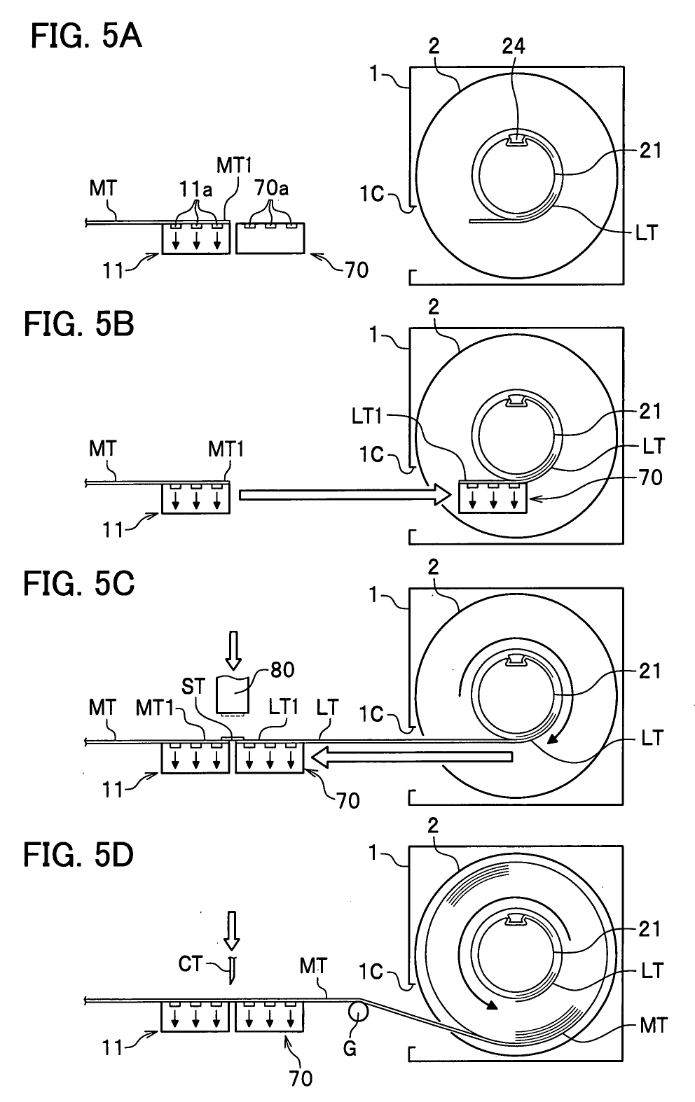

Below are described a magnetic tape cartridge manufacturing device W and a method of manufacturing a magnetic tape cartridge C using the same W with reference to FIG. 4 and FIGS. 5A to 5D.

First is described a configuration of the magnetic tape cartridge manufacturing device W.

The magnetic tape cartridge manufacturing device W is a device for winding up a predetermined length of the magnetic tape MT around the cup-shaped hub 21 of the reel 2 set in the cartridge case 1, from the magnetic tape MT wound in a so-called pancake shape.

As shown in FIG. 4, the magnetic tape cartridge manufacturing device W includes, as main components, a tape supply unit 10; a blade unit 30 for polishing a surface of the magnetic tape MT; a cleaning unit 40 for cleaning both surfaces of the magnetic tape MT; a tension control unit 50 for controlling a tension of the magnetic tape MT while traveling; the cartridge case supply unit 60 for supplying the stocked cartridge case 1 to a case setting part CS; a leader tape drawing-out unit 70 for drawing the leader tape LT out of the cartridge case 1 placed in the case setting part CS; a tape joining unit 80 for joining a drawn-out end of the leader tape LT and an end of the magnetic tape MT; and a cartridge discharging unit 90 for discharging the magnetic tape cartridge C. Further, the magnetic tape cartridge manufacturing device W has a plurality of guide rollers G for guiding the magnetic tape to the leader tape drawing-out unit 70, at appropriate places on a panel P. The magnetic tape cartridge manufacturing device W also includes an operation panel SP for operating the above-mentioned units and components.

The tape supply unit 10 supplies the magnetic tape MT to be wound around the reel 2 in the cartridge case 1. The tape supply unit 10 includes tape supply reels PC1,PC2 each having the magnetic tape MT wound therearound in the pancake shape. A drive unit not shown rotates the tape supply reel PC1 (or the tape supply reel PC2) at a predetermined rotating speed, to thereby supply the magnetic tape MT to the cartridge case 1. It is to be noted that, because the tape supply unit 10 includes the two tape supply reels PC1,PC2, the tape supply unit 10 can supply the magnetic tape MT without a break. For example, as soon as the tape supply reel PC1 is out of the magnetic tape MT, the tape supply reels PC1 is switched by the tape supply reels PC2.

The tape supply unit 10 has a tape adsorption unit 11 for adsorbing and holding an end MT1 of the magnetic tape MT, in a position facing the leader tape drawing-out unit 70. The tape absorption unit 11 is in a rectangular solid shape, and has a plurality of adsorption holes 11a (see FIG. 5A) on its surface. The tape absorption unit 11 can hold the end MT1 of the magnetic tape MT by adsorbing the same through the absorption holes 11a.

The cartridge case supply unit 60 stocks the cartridge case 1 in which the reel 2 with the leader tape LT wound therearound is set. The cartridge case supply unit 60 supplies the cartridge case 1 to the case setting part CS in such a state that the tape drawing-out opening 1C of the cartridge case 1 faces the leader tape drawing-out unit 70.

The case setting part CS is a unit in which the cartridge case 1 supplied from the cartridge case supply unit 60 is set. The case setting part CS holds the cartridge case 1, and winds the magnetic tape MT by rotating the reel 2. When the cartridge case 1 is set in the case setting part CS, the tape drawing-out opening 1C of the cartridge case 1 opens.

The leader tape drawing-out unit 70 is provided between the tape drawing-out opening 1C of the cartridge case 1 and the tape absorption unit 11, and draws the leader tape LT out of the cartridge case 1. The leader tape drawing-out unit 70 is in a rectangular solid shape, and has a plurality of adsorption holes 70a (see FIG. 5A) on its surface. The leader tape drawing-out unit 70 is connected to a drive unit not shown such as an air cylinder, and can freely travel between the tape adsorption unit 11 and the cartridge case 1.

The tape joining unit 80 joins the end MT1 of the magnetic tape MT and the other end LT1 (see FIG. 5) of the leader tape LT. The other end LT1 is an opposite end of the one end which is held between the cup-shaped hub 21 and the engagement member 24. The tape joining unit 80 is provided in a position where the tape absorption unit 11 and the leader tape drawing-out unit 70 face to each other. A tip of the tape joining unit 80 holds a splicing tape ST (see FIG. 5C) of a short length in such a manner that an adhesive side of the splicing tape ST faces the magnetic tape MT and the leader tape LT. The tape joining unit 80 is connected to a drive unit not shown, and can freely contact with or separate from surfaces of the magnetic tape MT and the leader tape LT.

Next is described a method of manufacturing the magnetic tape cartridge C using the magnetic tape cartridge manufacturing device W.

First, as shown in FIG. 5A, the end MT1 of the magnetic tape MT is adsorbed by the tape adsorption unit 11. The cartridge case 1 in which the reel 2 with the leader tape LT wound therearound is set in the case setting CS (see FIG. 4) in a state where the tape drawing-out opening 1C faces the leader tape drawing-out unit 70.

Next, as shown in FIG. 5B, the magnetic tape cartridge manufacturing device W inserts the leader tape drawing-out unit 70 through the tape drawing-out opening 1C into the cartridge case 1. The leader tape drawing-out unit 70 adsorbs the other end LT1 of the leader tape LT.

As shown in FIG. 5C, the magnetic tape cartridge manufacturing device W moves the leader tape drawing-out unit 70 having the adsorbed leader tape LT toward the tape absorption unit 11, to thereby draw the leader tape LT out of the cartridge case 1. The other end LT1 of the drawn-out leader tape LT is then provided in a position facing the end MT1 of the magnetic tape MT having been adsorbed by the tape absorption unit 11.

Then the magnetic tape cartridge manufacturing device W brings the tape joining unit 80 into contact with both the end MT1 of the magnetic tape MT and the other end LT1 of the leader tape LT, which is provided in the position facing the end MT1 of the magnetic tape MT. Thus the magnetic tape cartridge manufacturing device W attaches the splicing tape ST both to the magnetic tape MT and the leader tape LT to join the both.

As shown in FIG. 5D, the magnetic tape cartridge manufacturing device W makes the reel 2 rotate by the case setting part CS (see FIG. 4), and thus winds the magnetic tape MT around the reel 2 via the leader tape LT. After the magnetic tape cartridge manufacturing device W winds up a predetermined length of the magnetic tape MT, the magnetic tape cartridge manufacturing device W cuts off the magnetic tape MT with a tape cutter CT.

The magnetic tape cartridge manufacturing device W then attaches the leader pin 15 and the clip 16 (see FIG. 1) to the other end of the magnetic tape MT using a leader pin attaching unit not shown. This brings a manufacture of the single reel magnetic tape cartridge C to completion.

The completed single reel magnetic tape cartridge C is discharged from the cartridge discharging unit 90 as shown in FIG. 4. Then a new cartridge case 1 is set in the case setting unit CS, and the above-mentioned procedures are repeated to manufacture the magnetic tape cartridges C one after another.

In the magnetic tape cartridge and the method of manufacturing the same as described above, one end of the leader tape LT is held between the cup-shaped hub 21 and the engagement member 24. Hence, the bend 107 or the deviation 108 (see FIG. 7C) of the leader tape LT is not produced. This means that, when the magnetic tape MT is wound around the reel 2 via the leader tape LT, a local distortion is not produced in the magnetic tape MT. This can reduce a spacing loss between the magnetic tape MT and a servo write head. As a result, a recording/reproducing quality of a servo signal is enhanced, thus also enhancing the recording/reproducing quality of data.

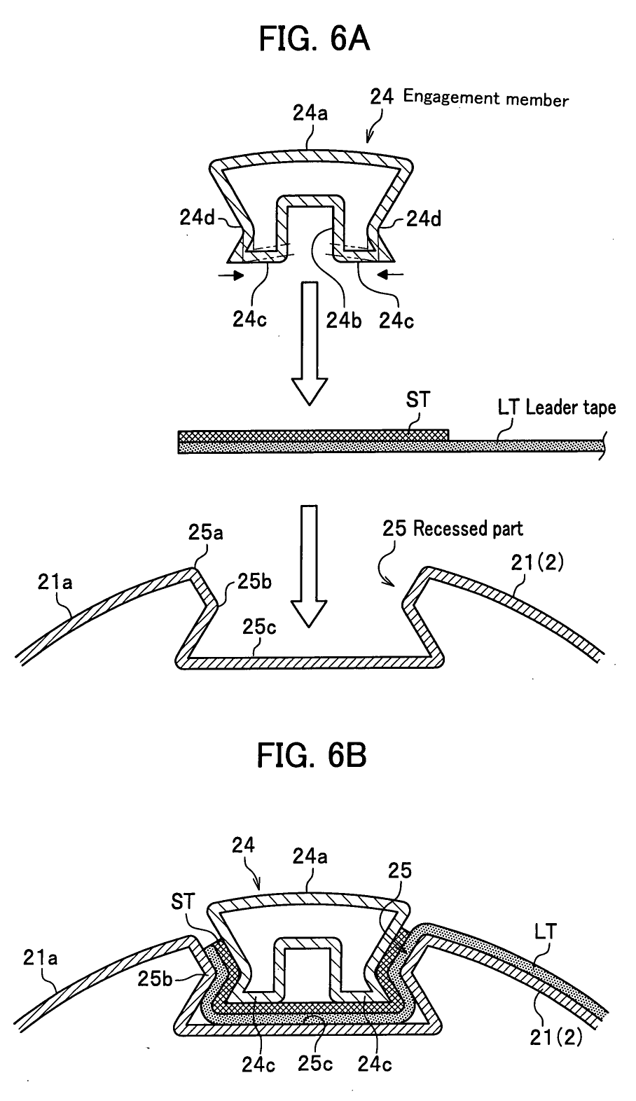

Next is described a magnetic tape cartridge and a method of manufacturing the same according to a second embodiment with reference to FIG. 6A and FIG. 6B. In the second embodiment, the same reference characters are assigned to the same elements as those in the first embodiment, and duplicate descriptions are omitted herefrom.

FIG. 6A and FIG. 6B are partial cross sectional views showing a reel of the magnetic tape cartridge according to the second embodiment. FIG. 6A shows a state before the reel is engaged with an engagement member, and FIG. 6B shows a state after the reel is engaged.

The magnetic tape cartridge C according to the second embodiment is the same as that according to the first embodiment, except that, as shown in FIG. 6A and FIG. 6B, the splicing tape ST as a protective tape is attached on an end portion of the leader tape LT, which is to be held between the cup-shaped hub 21 and the engagement member 24.

The leader tape LT is in some cases broken at a portion at which the leader tape LT is held between the cup-shaped hub 21 and the engagement member 24. Studies by the inventors have revealed that the leader tape LT having a thickness less than 15 μm could be easily broken.

In the magnetic tape cartridge C according to the second embodiment, the splicing tape ST as a protective tape is attached on the end portion of the leader tape LT. The protective tape makes it harder for the leader tape LT to be broken, when the leader tape LT is held between the cup-shaped hub 21 and the engagement member 24. Therefore, productivity (yield ratio) and quality (durability) of the magnetic tape cartridge C can be enhanced. A thickness of the splicing tape ST is preferably but not necessarily adjusted such that a total thickness of the same and the leader tape LT is 15 μm or more.

The embodiments according to the present invention have been explained as aforementioned. However, the present invention is not limited to those embodiments, and various modifications can be made without departing from the spirit and scope of the present invention.

For example, the first and second embodiments assume that the level difference d is generated between the curved portion 24a of the engagement member 24 and the outer circumferential surface 21a of the cup-shaped hub 21. However, a curvature of the curved portion 24a can be adjusted such that the level difference between the curved portion 24a and the outer circumferential surface 21a is gradually decreased toward a boundary portion therebetween, to finally generate no substantial level difference d. This can reduce the number of turns that the leader tape LT is wound around the reel 2.

The first and second embodiments use, as the leader tape LT, a conventional magnetic tape having a thickness larger than that of the magnetic tape MT. However, any other tape may be used.

In the first and second embodiments, the leader pin 15 and the clip 16 are directly attached to the end of the magnetic tape MT. However, an additional leader tape may be attached to the end of the magnetic tape MT, and the leader pin 15 and the clip 16 may be attached to an end of the additional leader tape.

In the first and second embodiments, the magnetic tape MT is used as a tape recording medium. However, any other tape-type recording media such as an optical recording tape may be used.

In the first and second embodiments, the leader tape LT and the magnetic tape MT are joined to each other via the splicing tape ST. However, the leader tape LT and the magnetic tape MT may be joined via any other adhesive tape or via any other means other than the adhesive tape. Further, the splicing tape ST is used as a protective tape in the first and second embodiments. However, any other tape may be used as the protective tape.

1. A method of manufacturing a single reel tape cartridge including a tape wound around a reel composed of a hub and an engagement member for engaging with the hub to hold a leader tape, comprising:
providing a leader tape having a first end and a second end;
holding the first end of the leader tape between the hub and the engagement member;
winding the leader tape around the reel;
setting the reel with the leader tape wound therearound, into a cartridge case;
drawing the second end of the leader tape out of the cartridge case;
joining the second end of the leader tape to the tape; and
winding the tape, which is joined to the hub via the leader tape, around the reel.

2. The method according to claim 1, wherein the leader tape is wound around the hub one or more turns to reduce a level difference between the hub and the engagement member.

3. The method according to claim 1, wherein a thickness t of the leader tape, the number of turns n of winding the leader tape around the reel, and a height of a level difference d between the hub and the engagement member satisfy a relation represented by the following expression (1):
Level difference d×90%≦Thickness t×Number of turns n (1)

4. The method according to claim 1, wherein a thickness of the tape is 6.6 μm or less.

5. The method according to claim 1, further comprising attaching a protective tape to a portion nearer to the first end of the leader tape, at which the leader tape is held between the hub and the engagement member.

6. A single reel tape cartridge comprising:
a tape;
a reel around which the tape is wound;
a cartridge case for accommodating the reel; and
a leader tape joining the magnetic tape and the reel,
wherein the reel includes a hub around which the tape and the leader tape are wound, and an engagement member configured to engage with the hub, and
wherein the first end of the leader tape is held between the hub and the engagement member, and the second end of the leader tape is joined to the tape.

7. The single reel tape cartridge according to claim 6, wherein the leader tape is wound around the hub one or more turns.

8. The single reel tape cartridge according to claim 6, wherein a thickness t of the leader tape, the number of turns n of winding the leader tape around the reel, and a height of a level difference d between the hub and the engagement member satisfy a relation represented by the following expression (1):
Level difference d×90%≦Thickness t×Number of turns n (1)

9. The single reel tape cartridge according to claim 6, wherein a thickness of the tape is 6.6 μm or less.

10. The single reel tape cartridge according to claim 6, wherein a protective tape is attached to a portion nearer to the first end of the leader tape, at which the leader tape is held between the hub and the engagement member.
